(19) United States
(12) Patent Application Publication
(10) Pub. No.: US 2005/0051134 A1
(43) Pub. Date: Mar. 10, 2005

(54) Electronic throttle ice break method and apparatus

(76) Inventors: Tyrus J. Valascho, Clarkston, MI (US); Paul A. Bauerle, Fenton, MI (US)

Correspondence Address: CHRISTOPHER DEVRIES;General Motors Corporation, Legal Staff, Mail Code 482-C23-B21, P.O. Box 300, Detroit, MI, 48265-3000, US

(21) Appl. No.: 10/656,975

(22) Filed: Sep. 5, 2003

(51) Int. Cl. F02D 11/10

(52) U.S. Cl. 123/399

(57) ABSTRACT

A method and apparatus for removing an ice blockage from a throttle body comprising heating an electric motor in a throttle body to melt the ice blockage.

### TECHNICAL FIELD

The present invention relates to control systems for internal combustion engines, and more particularly to control systems for an electronic throttle.

### BACKGROUND OF THE INVENTION

An important facet of combustion engine control is the regulation of air flow into a cylinder by a throttle and accordingly the quantity of fuel delivered into the cylinder. In an internal combustion engine (ICE) a throttle, having a movable throttle plate, directly regulates the power produced by the ICE at any operating condition by regulating the air flow into the ICE. The throttle plate is positioned to increase or decrease air flow into the ICE. The ICE acts as an air pump with the mass flow rate of air entering the ICE varying directly with throttle plate angular position. For any given fuel-air mixture, the power produced by the ICE is directly proportional to the mass flow rate of air into the ICE controlled by the throttle plate position.

Electronic throttle control (ETC) systems replace the mechanical pedal assemblies that are currently used in vehicles. ETC systems enhance overall engine management and improve the control of an ICE. ETC sensors and actuators eliminate the mechanical linkages that are used to connect an accelerator pedal to a throttle body. ETC sensors factor input from an accelerator pedal and other vehicle variables and systems and transfer it to an engine control system in real time. The engine control system modulates the air/fuel flow to the engine by modulating an electronic throttle. Direct control of the engine is shifted from the driver to the engine control system to improve performance of an ICE.

Under certain environmental and operating conditions moisture in a solid state (ice or snow) may build up in the throttle body, impeding the rotation of a throttle plate. As the throttle plate directly controls the power output of an engine any impediment to the movement of the throttle plate will affect the performance of the engine.

### SUMMARY OF THE INVENTION

The present invention is a method and apparatus to remove ice or snow blockage from a throttle body. The present invention utilizes the heat that is generated by an electric motor in an ETC system to melt or soften the ice that is creating a blockage in the throttle body. In the preferred embodiment, when an ice blockage occurs the electric motor/throttle plate may not be able to move causing the control method of the present invention to increase the duty cycle for the current provided to the electric motor. The current in conjunction with the resistance of the electric motor coils will generate heat according to I²R heating losses, where I is the current provided to the electric motor and R is the electrical resistance of the coils of the electric motor. In alternate embodiment of the present invention, kinetic energy provided by the mechanical “striking” of the throttle plate, singly or in combination, with the heat provided by the electric motor may be used to clear a throttle body.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a functional diagram of an electronic throttle body of the present invention; and

FIG. 2 is a flowchart of a preferred method of the present invention.

### DESCRIPTION OF THE PREFERRED EMBODIMENT

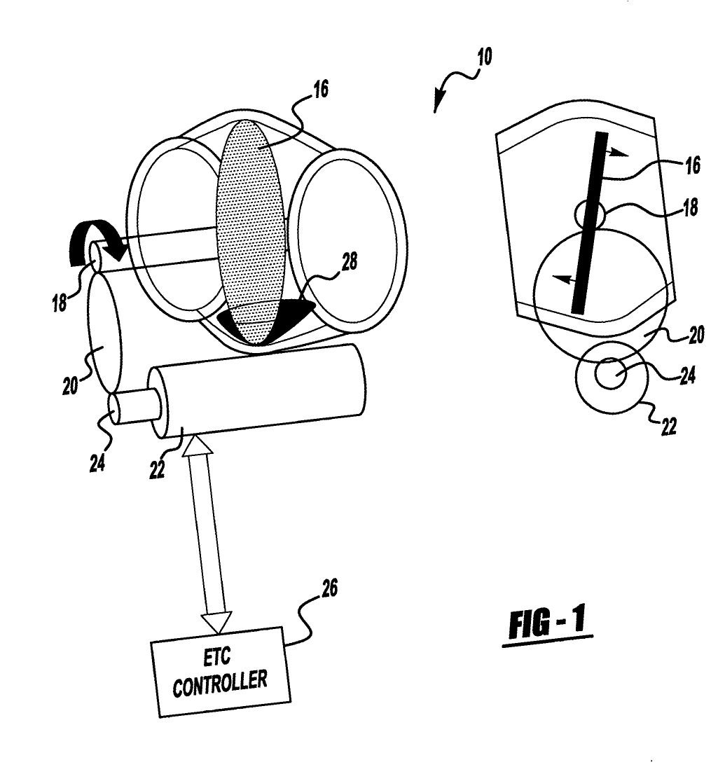

Referring to FIG. 1, an ETC throttle body 10 is shown. The throttle body 10 includes a throttle plate of blade 16, a rotational shaft 18 coupled to the throttle plate 16, a gear set arrangement 20, and an electric motor 22 having an output shaft 24. The electric motor 22 is controlled by a stand alone ETC system 26, or in alternate embodiments is integrated into a standard vehicle controller such as a powertrain controller or body controller. The electric motor 22 may comprise any electric motor technology including, but not limited to, DC motors, AC motors, induction motors, permanent magnet brushless motors, stepper motors, and synchronous motors.

During the operation of the throttle body, the ETC controller 26 will provide a position command to the electric motor 22 and the electric motor 22 will provide position and speed feedback to the ETC controller 26. Position and speed feedback may be provided by a resolver, a potentiometer, a rotary voltage displacement transducer (RVDT) or rotary encoder (absolute or incremental), but is not limited to such. The electric motor 22 and motor shaft 24 will rotate according to the position command generated by the ETC controller 26. The electric motor shaft 24 is coupled to the gear set 20 which is further coupled to the rotational shaft 18 of the throttle plate 16 to rotate the throttle plate 16. While generally the gear ratio can be selected as to any ratio suitable as to the conditions of position resolution, response, and torque output, the gear ratio is preferably one to nineteen. In alternate embodiments of the present invention, the motor 32 will directly drive the throttle plate 16, eliminating the gear set 20. The electric motor 22 is preferably placed adjacent to the lowest part of the throttle body 10 where ice 28 is most likely to accumulate. The throttle body 10 is constructed to efficiently conduct heat from the electric motor 22 to melt the ice 28.

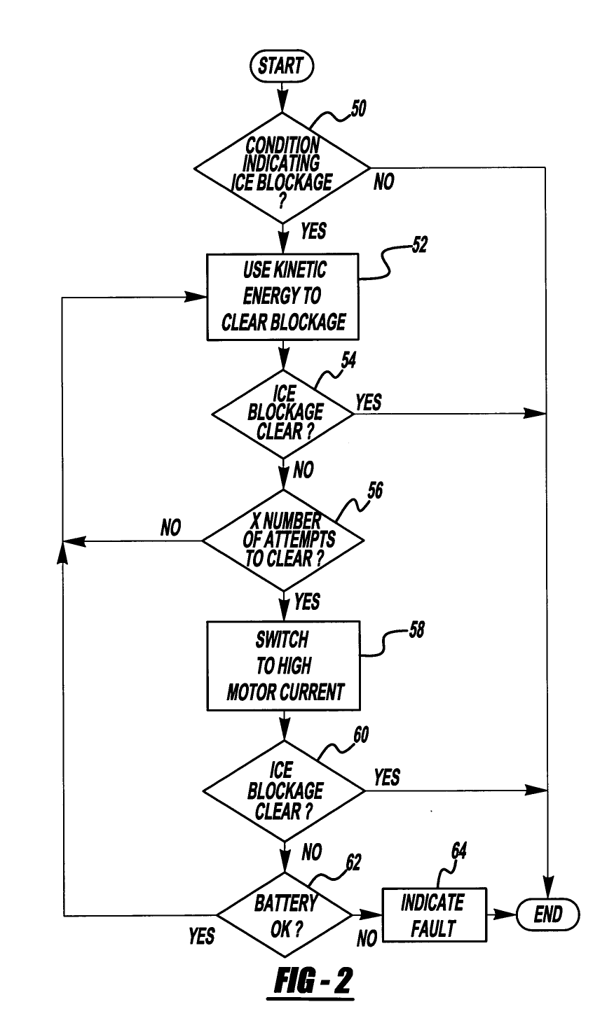

FIG. 2 is a preferred method of the present invention shown in flow chart form. Starting at block 50, the ETC controller 26 will determine if there is an ice blockage in the throttle body 10. The determination will be based on external temperature (the algorithm may be disabled above twenty-five° C.), throttle position, feedback from the throttle body, and battery voltage representing the state of charge of a battery in the vehicle, but is not limited to such. The driver of the vehicle may be notified of he blocked throttle condition by a graphic interface with such messages as “Wait To Start” and when the blockage has been cleared “Cranking Can Be Attempted” or “Retry Cranking After x Seconds”. If there is no ice blockage the method will end. At block 52, if an ice blockage has been detected the ETC controller 26 will initially modulate the position of the throttle plate to “strike” the ice blockage in an attempt to loosen the throttle plate 16 and clear the throttle body 10. At block 54, if the ice blockage has been cleared the method will end. The preferred number of times the ice blockage is hit is ten times as determined by block 56.

At block 58, if the movement or “striking” of the throttle plate 16 has not loosened or removed the ice blockage to allow free movement of the throttle plate 16, the throttle plate 16 will be commanded to a position where the ice blockage prevents movement of the throttle plate 16. Upon detection of the resistance of the ice blockage, the duty cycle or amount of current to the electric motor 22 will be increased for a few second to a few minutes, preferably thirty seconds to three minutes, but any time period is within the scope of the present invention. The electric motor 22 will thus be in a locked rotor condition and the current supplied to the electric motor 22 will be converted to heat.

The throttle body 10 has been constructed to allow for the conduction of heat to the bottom (as referenced to a vertical direction) of the throttle body 10 where water or ice could collect. After the expiration of the time of the increased duty cycle to the electric motor 22, the ETC controller 26 will again evaluate whether the ice blockage has been removed at block 60. During the execution of this present method, the state of charge of a battery providing power to the electric motor 22 will be monitored at block 62 to ensure that the heating of the electric motor 22 does not completely discharge the battery. If the battery is in a low state of charge, the method will end and a fault indicator will be activated for the operator of the vehicle at block 64. If the battery charge is within acceptable limits, the method can return to block 52 to attempt to clear the blockage.

In alternate embodiments of the present invention, the duty cycle commanded to the electric motor 22 can vary during the initial start of the present method to provide rapid heating early in the event by commanding a relatively higher duty cycle and gradually decreasing the duty cycle to prevent overheating of the various electric and electronic components in the vehicle. The heating process may repeat until the battery voltage is below a certain threshold or the ice is melted sufficiently.

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, the specification and the following claims.

1. A method for removing an ice blockage from a throttle body comprising heating an electric motor in a throttle body to melt the ice blockage.

2. The method of claim 1 further comprising rotating the throttle blade to contact the ice blockage.

3. The method of claim 1 further comprising determining if an ice blockage is in the throttle body.

4. A throttle body for use in a vehicle with an internal combustion engine comprising:
a throttle plate;
an electric motor operatively coupled to said throttle plate;
wherein upon detection of an ice blockage said electric motor is heated to melt said ice blockage.

5. The throttle body of claim 4 wherein said electric motor is mounted to the underside of the throttle body.

6. The throttle body of claim 4 wherein said electric motor is a DC motor.

7. The throttle body of claim 4 wherein said DC motor includes a permanent magnet field in the stator.

8. The throttle body of claim 4 wherein said electric motor is a stepper motor.

9. A method of removing ice from a throttle body in a vehicle comprising:
actuating a throttle plate in the throttle body to impact the ice; and
heating an electric motor coupled to said throttle plate to heat the throttle body and melt the ice.

10. A method of removing ice from a throttle body in a vehicle comprising actuating a throttle plate in the throttle body to impact the ice.
